(19) United States
(12) Patent Application Publication
(10) Pub. No.: US 2025/0310186 A1
(43) Pub. Date: Oct. 2, 2025

(54) METHODS FOR ENSURING DISTRIBUTED APPLICATION PERFORMANCE THROUGH SERVICE QUALITY AWARE DEVICE CLOUD ORCHESTRATION

(71) Applicant: MEDIA TEK INC., Hsinchu (TW)

(72) Inventors: Bong Ho KIM, San Jose, CA (US); Doru Calin, San Jose, CA (US)

(21) Appl. No.: 19/089,167

(22) Filed: Mar. 25, 2025

Related U.S. Application Data
(60) Provisional application No. 63/571,475, filed on Mar. 29, 2024.

(51) Int. Cl. H04L 41/0806; H04L 41/5009; H04L 41/5067; H04W 24/08

(52) U.S. Cl. CPC H04L 41/0806; H04L 41/5009; H04L 41/5067; H04W 24/08

(57) ABSTRACT

In an aspect of the disclosure, a method, a computer-readable medium, and a system are provided. The method is implemented by one or more computing devices. The one or more computing devices obtain a service profile for a distributed application. The service profile includes microservice parameters defining compute resource requirements for a plurality of microservices of the distributed application; and communication parameters defining communication resource requirements between the plurality of microservices. The one or more computing devices distribute the plurality of microservices across a plurality of worker nodes based on the service profile. The one or more computing devices configure communication channels between the distributed microservices based on the communication parameters.

### CROSS-REFERENCE TO RELATED APPLICATION(S)

This application claims the benefits of U.S. Provisional Application Ser. No. 63/571,475, entitled “Methods for ensuring distributed application performance through service quality aware device cloud orchestration” and filed on Mar. 29, 2024, which is expressly incorporated by reference herein in its entirety.

### BACKGROUND

### Field

The present disclosure relates generally to communication systems, and more particularly, to techniques of methods for ensuring distributed application performance through service quality aware device cloud orchestration.

### Background

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and a system are provided. The method is implemented by one or more computing devices. The one or more computing devices obtain a service profile for a distributed application. The service profile includes microservice parameters defining compute resource requirements for a plurality of microservices of the distributed application; and communication parameters defining communication resource requirements between the plurality of microservices. The one or more computing devices distribute the plurality of microservices across a plurality of worker nodes based on the service profile. The one or more computing devices configure communication channels between the distributed microservices based on the communication parameters.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric slot.

FIG. 6 is a diagram showing an example of an UL-centric slot.

FIG. 7 is a diagram illustrating a service profile and distributed process communication map.

FIG. 8 is a diagram illustrating an example deployment of the microservices.

FIG. 9 is a diagram illustrating an exemplary visualization of a service profile.

FIG. 10 illustrates a flow chart of a process for providing distributed application performance through service quality aware device cloud orchestration.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

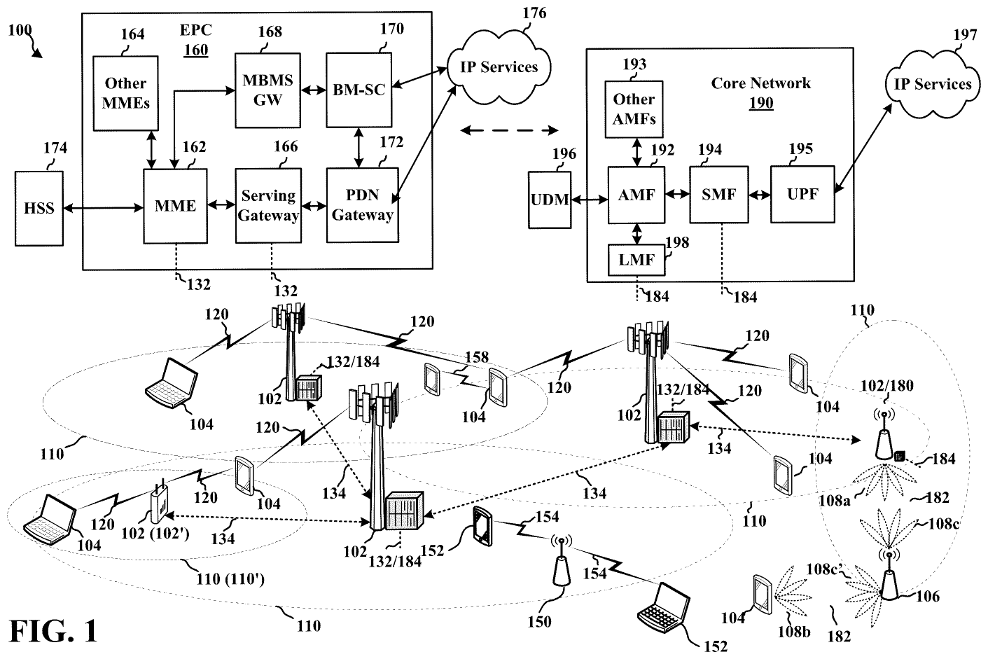

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to 7 MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

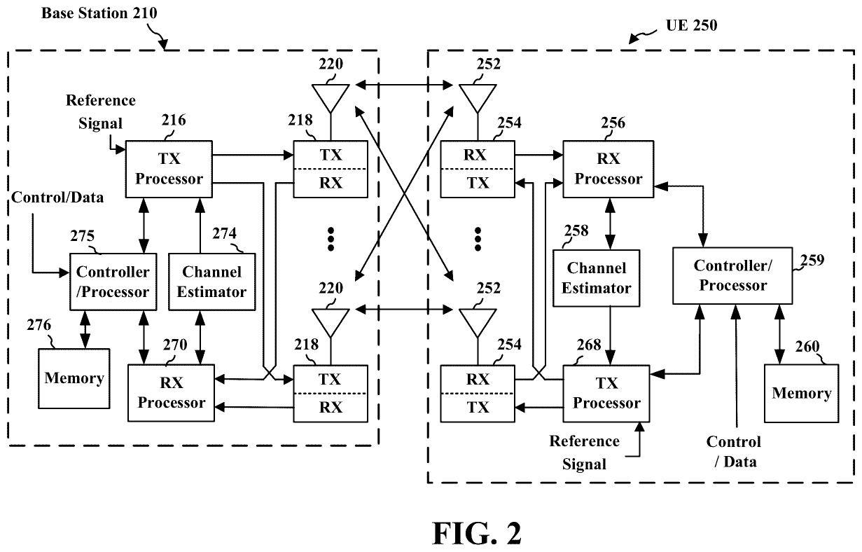

FIG. 2 is a block diagram of a base station 210 in communication with a UE 250 in an access network. In the DL, IP packets from the EPC 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate mapping matching, onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the EPC 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the EPC 160. The controller/processor 275 is also responsible for error detection using an ACK and/or NACK protocol to support HARQ operations.

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHZ), massive MTC (mMTC) targeting non-backward compatible MTC techniques, and/or mission critical targeting ultra-reliable low latency communications (URLLC) service.

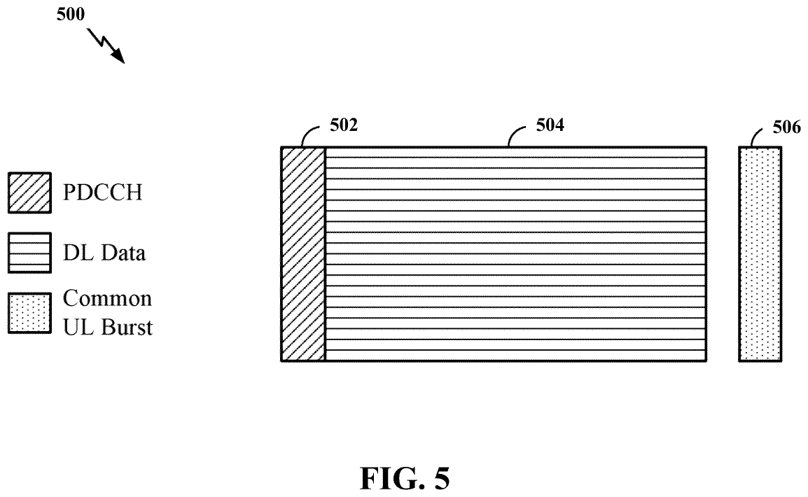

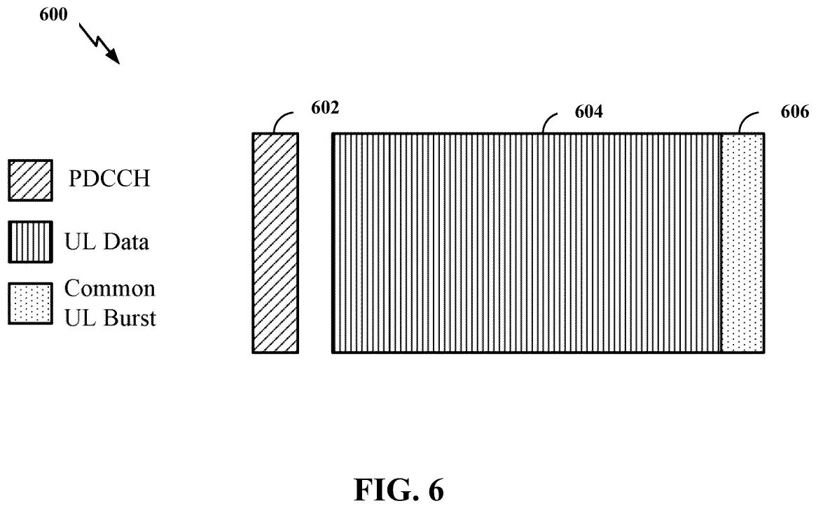

A single component carrier bandwidth of 100 MHz may be supported. In one example, NR resource blocks (RBs) may span 12 sub-carriers with a sub-carrier bandwidth of 60 kHz over a 0.25 ms duration or a bandwidth of 30 kHz over a 0.5 ms duration (similarly, 50 MHz BW for 15 kHz SCS over a 1 ms duration). Each radio frame may consist of 10 subframes (10, 20, 40 or 80 NR slots) with a length of 10 ms. Each slot may indicate a link direction (i.e., DL or UL) for data transmission and the link direction for each slot may be dynamically switched. Each slot may include DL/UL data as well as DL/UL control data. UL and DL slots for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

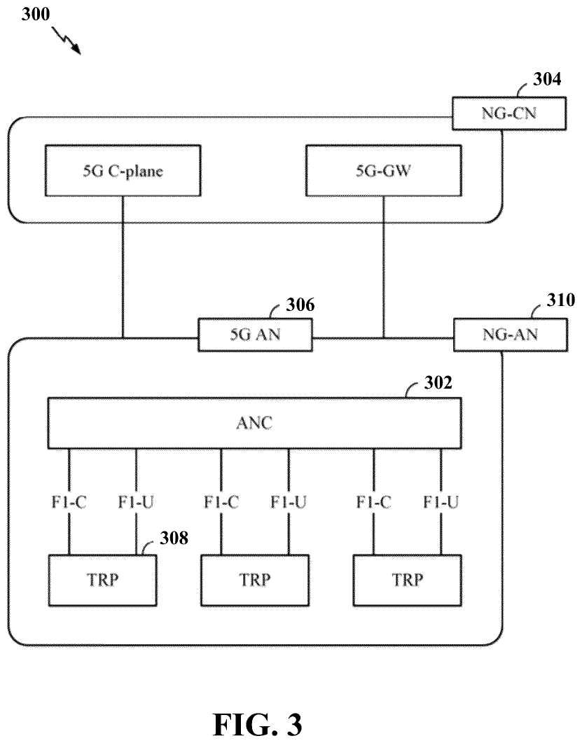

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

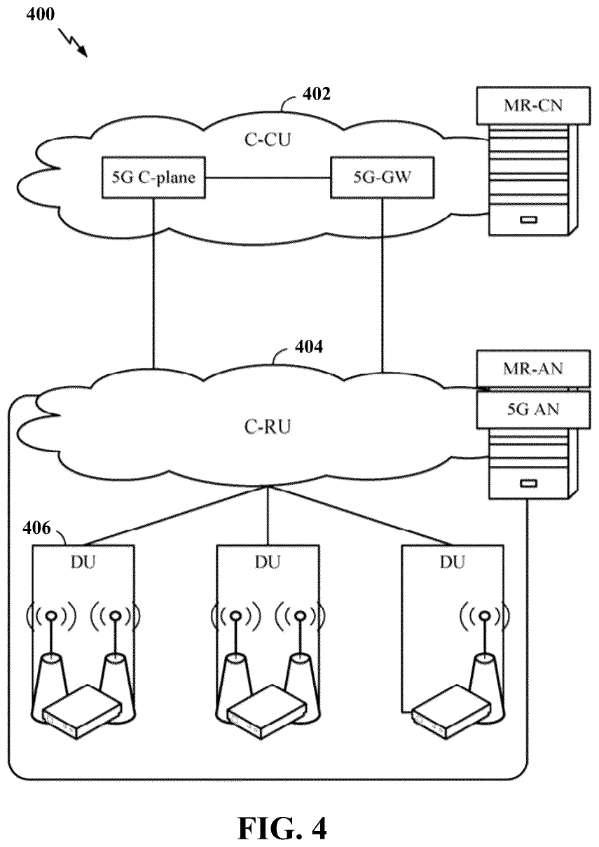

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric slot. The DL-centric slot may include a control portion 502. The control portion 502 may exist in the initial or beginning portion of the DL-centric slot. The control portion 502 may include various scheduling information and/or control information corresponding to various portions of the DL-centric slot. In some configurations, the control portion 502 may be a physical DL control channel (PDCCH), as indicated in FIG. 5. The DL-centric slot may also include a DL data portion 504. The DL data portion 504 may sometimes be referred to as the payload of the DL-centric slot. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric slot may also include a common UL portion 506. The common UL portion 506 may sometimes be referred to as an UL burst, a common UL burst, and/or various other suitable terms. The common UL portion 506 may include feedback information corresponding to various other portions of the DL-centric slot. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric slot and alternative structures having similar features may exist without necessarily deviating from the aspects described herein.

FIG. 6 is a diagram 600 showing an example of an UL-centric slot. The UL-centric slot may include a control portion 602. The control portion 602 may exist in the initial or beginning portion of the UL-centric slot. The control portion 602 in FIG. 6 may be similar to the control portion 502 described above with reference to FIG. 5. The UL-centric slot may also include an UL data portion 604. The UL data portion 604 may sometimes be referred to as the pay load of the UL-centric slot. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric slot may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric slot and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

Distribution and communication are fundamental concepts in distributed application architectures. Such architectures use distributed computing resources to enhance performance. Effective application distribution necessitates interactions between application modules, microservices, or remote functions, ranging from simple point-to-point interactions to complex, large-scale clusters and dynamic service-oriented architectures. Furthermore, communication across system boundaries is essential for scaling software systems and improving their availability.

As distributed computing systems become more dynamic, the complexity of their architectures increases. In this context, managing Quality of Service (QOS) involves allocating network resources for optimal performance. QoS is used for maintaining the responsiveness and reliability of high-priority services, particularly under heavy network loads or in shared environments.

For developers, understanding the implications of service deployment in production can be challenging. This complexity, coupled with a lack of knowledge about the underlying systems' capabilities, may lead to increased resource consumption and degraded performance. This is because the performance of an application is significantly impacted by the infrastructure's configuration and the distribution of remote application modules.

On the distributed node side, connection management and the threading model are major aspects to consider. Establishing a connection can be time-consuming, and the threading model determines how requests are processed-either synchronously, which blocks a thread until a response is received, or asynchronously, which invokes a callback when the response arrives. Beyond the node level, the network itself is a central component in distributed applications, which impacts scalability and affects performance.

This disclosure introduces a mechanism for optimized orchestration to achieve high performance in distributed microservices and/or distributed functions environments. It involves conveying key application and network-related performance requirements, defined as the “Service Profile,” from an application developer to the system orchestrator. The “Service Profile” in a distributed resource-sharing environment defines a set of parameters for managing resource allocation and service quality. These parameters may include, but are not limited to, priority levels, bandwidth allocation, latency sensitivity, jitter control, traffic shaping, congestion management, service availability, fairness, policy compliance, scalability, adaptive QoS, resource reservation, monitoring, and other related parameters.

This disclosure also provides a mechanism to generate a service profile for a distributed application for the application developers.

The “Service Profile” addresses key service requirements in a distributed microservices, application modules, or remote functions environment. The term “Microservice” used in this disclosure may represent any types of application modules that can be distributed and remotely work together. A service profile should include a variety of factors to satisfy the diverse needs of microservices for optimal performance, reliability, and user experience. QoS within a microservices architecture involves managing and monitoring network resources to guarantee performance across different types of traffic, as well as controlling the utilization of computing resources, such as Central Processing Unit (CPU) and memory. QoS is vital for maintaining the responsiveness and reliability of high-priority services, especially when faced with heavy network loads (e.g., system overload conditions) or in environments that share computing resources and networks.

Developers should consider three key aspects—Design, Operation, and Performance—from the outset of implementation. In certain configurations, the “Design aspect” includes: service decomposition into microservices, Application Programming Interface (API) gateway for communication with remote modules, synchronous or asynchronous communications, traffic shaping, caching, etc.

In certain configurations, the “Operation aspect” includes: service discovery, load balancing, scalability, etc. These items are integral to the application's design and implementation, and the following performance aspect parameters are included in the service profile and utilized by the orchestrator throughout the real-time lifecycle of the distributed application. The detailed text structure/format of the service profile will be described in further detail below.

In certain configurations, the “Performance aspect” includes:

(1) Latency: Minimize network delay (latency) between microservices, especially for synchronous communications. Low latency is important for achieving quick response times, which is important in user-facing applications or when microservices frequently communicate with each other.

(2) Bandwidth: Sufficient network bandwidth is allocated to accommodate the data transfer needs of microservices. This is also important, particularly when microservices exchange large volumes of data or high-resolution media files.

(3) Packet Loss: Implement strategies to minimize packet loss. High packet loss can lead to data corruption, retransmissions, and increased latency. Using reliable transport protocols and optimizing network configurations can help reduce packet loss.

(4) Adaptive QoS: Implement adaptive QoS mechanisms that can dynamically adjust priorities and resource allocation based on real-time network performance and service demands.

(5) Priority Levels: Define different priority levels for different types of traffic. For instance, important service requests might be given higher priority compared to batch processing jobs or data backup activities.

(6) Bandwidth Allocation: Allocate bandwidth based on the importance and needs of each microservice. High-priority services may require guaranteed bandwidth for consistent performance.

(7) Latency Sensitivity: Identify services that are latency-sensitive and require low response times. QoS policies can prioritize these services in order to be less affected by network congestion.

(8) Jitter: Jitter refers to the variability in packet delay. For services requiring real-time data processing or streaming, jitter is important to application quality.

(9) Service Availability: Provide high availability for important services by prioritizing their traffic, especially in scenarios where network resources are constrained.

(10) Resource Reservation: For very important services, reserve network resources for uninterrupted performance.

(11) Scheduling: While prioritizing certain types of traffic, it's important to prevent lower-priority traffic from being excessively degraded. This is determined by the scheduler policies implemented by the Orchestrator (e.g., something similar to forms of Proportional Fairness, which also takes into account the services history).

(12) QoS Policies: Define and enforce QoS policies to prioritize network traffic. This is particularly important for time-sensitive applications; critical traffic (e.g., real-time data) obtains the necessary bandwidth and low latency.

(13) Monitoring, Logging and Adjusting: Implement comprehensive monitoring and logging to track the health, performance, and usage of microservices, and adjust QoS policies as needed based on changing network conditions and service requirements. This aids in quick debugging and performance tuning.

Once a distributed application has been implemented, the application designers, which include the developers, need to prepare a list of performance requirements for the network nodes and user devices for each microservice or distributed module. Additionally, they are required to specify the communication performance requirements between/among the microservices. This set of structured information is referred to as a “Service Profile.”

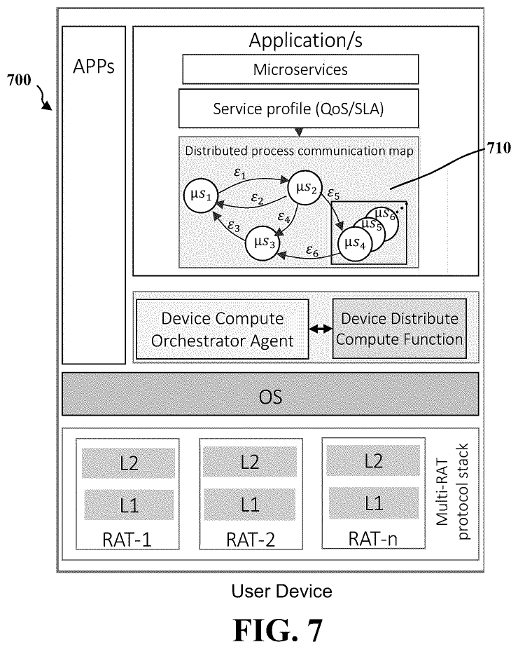

FIG. 7 is a diagram 700 illustrating a service profile and distributed process communication map. Specifically, FIG. 7 illustrates a user device running a distributed application including six microservices, as an exemplary embodiment. The distributed process communication map 710 depicted in FIG. 7 provides a logical view of the service profile. This map 710 reveals that three microservices (μs1, μs2, μs3) are instantiated individually, while the remaining three (μs4, μs5, μs6) are instantiated as a group. FIG. 7 also shows communication arrows between the microservices, representing the communication pathways (ε1 through ε6) among them.

A service profile for each distributed application may contain the following key information in a structured format and be deployed in real-time when the application starts, including:

Each microservice in a service profile may be defined with its compute resource requirements. The example parameters include, but are not limited to, CPU, memory, and storage resource requirements per node or microservice.

Each communication between the remote processes or microservices in a service profile may be defined with specific communication resource requirements or conditions and perceived link utilization. The example metrics include, but are not limited to, source and destination microservices for the traffic direction, message rate, message size, link delay, link delay variation, message response time delay, and packet loss rate between the connected nodes or microservices.

A service profile may be prepared in a structured format for an orchestrator to use as input. Subsequently, the service profile may be transformed into another format tailored for the specific orchestrator to be used for application deployment. This enables the orchestrator to optimally distribute microservices across worker nodes and configure the communication channels to satisfy the requirements for application QoS and/or Quality of Experience (QoE), performance, and reliability throughout the real-time lifecycle of the distributed application. It allows the orchestrator to meet the performance and resource requirements effectively.

A service profile, or the location of the service profile for a distributed application, may be installed on the device when the main application is installed.

When a distributed application is initiated, a device cluster that may contain user devices and network devices is formed, and a main orchestrator is elected among the devices in the device cluster. The service profile is sent to the orchestrator, which uses it as a source for decision-making for the application cluster creation by the orchestrator.

When the orchestrator forms an application cluster with remote devices, which may include user devices and network devices, only the applicable parts of the service profile corresponding to a worker node may be delivered to the target worker node, depending on the role of the node.

While the distributed application is in operation, each microservice or the underlying worker node (the compute node supporting the microservice) constantly monitors the application's behavior or performance. This may include CPU, memory, and storage utilization per node; network link utilization such as packet rate, bandwidth, message rate, and traffic pattern; and network performance metrics such as packet delay, delay variation, packet error rate and message error rate between the connected nodes. The performance monitoring results are fed back to the orchestrator to maintain or make updates for optimal application cluster performance.

The orchestrator constantly evaluates the application QOS if the application performance is objectively measurable, which includes performance measurement of each microservice and the connectivity performance measurement between microservices.

Alternatively, the orchestrator constantly predicts the perceived user perspective of application QoE based on any algorithm or method, including Machine Learning (ML) models, with continuous performance measurement of each microservice and the communication measurements between microservices.

If the observed application performance (QOS and/or QoE) does not meet the desired performance, the orchestrator may actively adjust the application cluster such as excluding some low performing devices, adding new devices, altering network connectivity, or interacting with the systems on the devices in the cluster to reserve needed resources or configure network schedulers and protocols to enhance application performance.

A service profile contains the compute and communication resource and performance requirements for a distributed application and is not tied to the physical topology of the user devices and network devices. A single worker node may host all distributed processes, and communication between these processes can still function within the same physical device. There may be multiple physical worker nodes in a cluster, and the orchestrator is responsible for distributing the microservices to the most suitable worker devices.

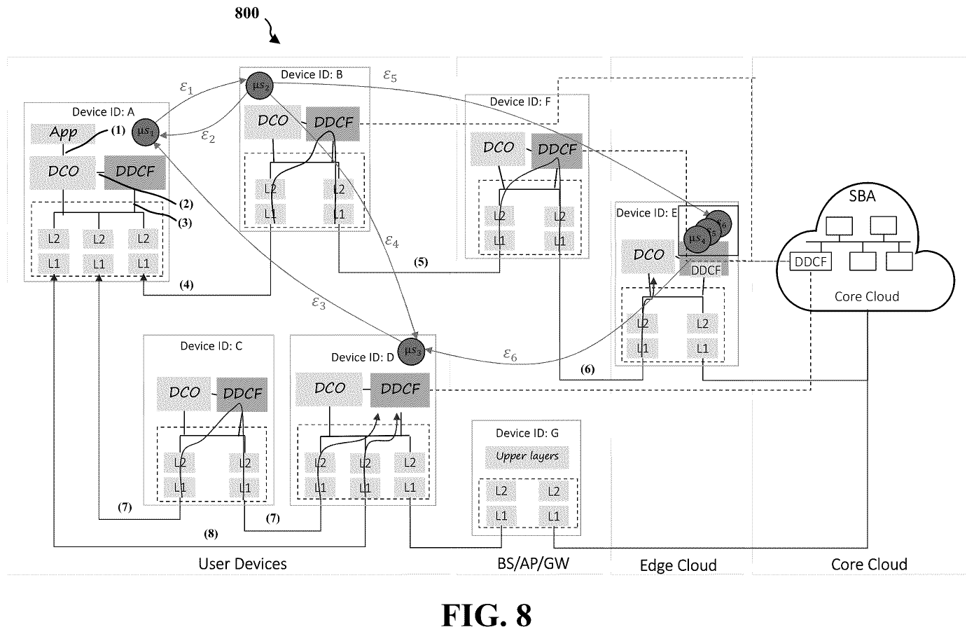

FIG. 8 is a diagram illustrating an example deployment of the microservices, reflecting the distributed process communication map diagram shown in FIG. 7. As illustrated in FIG. 8, the system includes a plurality of devices configured to operate in a distributed computing environment, forming a device cluster. For example, Device A may be implemented as a smartphone, tablet, or personal computer (PC) associated with a user. In a crowded environment, such as a mall or public area, multiple users may be present, each with their respective devices (e.g., Device A, Device B, Device C, and Device D).

Microservice 1 (μs1) is instantiated on Device A, Microservice 2 (μs2) is instantiated on Device B, Microservice 3 (μs3) is instantiated on Device D, and the remaining microservices (μs4, μs5, and μs6) are instantiated on the same Device E. This topology and the list of active devices can be dynamically changed depending on network and/or device conditions.

In FIG. 8, Devices A-D represent user devices, while Device F and Device G represent network nodes, such as base stations (BSs), access points (APs) or gateways (GWs) that provide connectivity between the user devices and/or provide connectivity between the user devices and an operator's network. Device E is a network device within the operator's network. Therefore, Devices A-G are also called network entities in the network.

Distributed compute resource sharing is enabled in Devices A-G, as they contain the Device Compute Orchestrator (DCO) and Device Distribute Compute Function (DDCF) functions, and they are in the same device cloud cluster. Devices A, B, D and E provide compute resources for the microservices installed on their nodes. Devices C and F provide connectivity for the other devices, and the orchestrator may utilize Devices C and F when necessary to maintain the application performance.

Specifically, the user devices A and D support three Radio Access Technologies (RATs), while the user devices B and C support two RATs. The user device B is connected to the network node F, and the network node F is further connected through the network node E in the edge cloud to the core cloud of the network operator. The user device D is connected to another network node G, which is further connected to the core cloud of the same network operator. Therefore, the user devices B and D are subscribers of the same network operator, while the user devices A and C may be unsubscribed user devices, which are not subscribed to the network operator in this exemplary embodiment.

In the architecture 800, if the network supports granting remote compute resource to user devices via device cloud, the DDCF in the core network configures the network nodes in the core cloud, edge cloud, hyperlocal cloud, and the subscribed user devices (e.g., the user devices B and D). The dotted lines from the DDCF in the core cloud to the DDCFs in the network nodes E and F, and to the subscriber user devices B and D indicate a distributed device cloud function instantiation and/or configuration scenario.

Then, the network nodes supporting remote compute resources (e.g., the network nodes E and F) transmit their intention (via requests) to participate in the compute resource sharing, and the intermediate user device B adds its own device ID B into the forwarding message to indicate the traffic path. During this phase, a service bearer needs to be created between the renter and the proxy device (e.g., the user device B), and intermediate GTP or IP tunnels may be also established if the network requires GTP or IP tunneling. The network tunnels are transparent to tenant devices (e.g., the user device A).

The following steps describe the buildup of the device cloud frame switching table through the embodiment illustrated in FIG. 8. At flow (1), the user device A runs an application. The user device A estimates of the amount of compute resource may be required by the application (main application). The user device A may further estimate the amount of compute resources is higher than what user device A is able to provide. At flow (2), the DCO (main orchestrator) hosted by the user device A triggers the DDCF of the user device A to discover remote compute resources.

At flow (3), if the user device A is not currently in a subnetwork, then all the RATs of the user device A attempt to connect to neighboring user devices. Subsequently, the neighboring user devices (e.g., user devices B, C and D) that are able to collaborate establish connectivity to the user device A using the corresponding RAT specific protocol, including security mechanisms. At flow (4), after a subnetwork is established, the DDCF of the user device A broadcasts a subnetwork message, namely a resource inquiry message via all connected RATs. This resource inquiry message contains information of a destination device and the source device (i.e., the user device A). For example, the resource inquiry message may include information such as (destination device ID=X, source device ID=A), where the device ID ‘X’ indicates any subnetwork device ID.

At flow (5), the user device B, upon receiving the resource inquiry message from the user device A, forwards the resource inquiry message to the network node F. At flow (6), the network node F, upon receiving the resource inquiry message forwarded by the user device B, forwards it to the network node E in the edge cloud. Every intermediate device (e.g., the user device B and the network node F), along the path between the tenant and the renter, updates the device cloud frame forwarding table that contains neighboring information (destination device ID, destination device IP address, RAT output port, and next hop device ID). If the network node E is willing to provide the requested compute resources, it sends an acknowledgement message with its IP address back to the user device A (through the intermediate devices F and B). Upon receiving the acknowledgement message, the user device A has the information about the network node E, including information as to how to reach out to the network node E.

At flows (7) and (8), another exemplary traffic flow is between the user devices A and D, which shows a potential frame switching loop issue, because the user device D receives duplicated resource inquiry messages, including one message forwarded by the user device C via the flow (7) (i.e., the user device A to the user device C, and then to user device D), and another message delivered directly from the user device A via the flow (8) (i.e., the user device A to user device D), through different RATs. In this case, the duplicated resource inquiry messages may be identified by the message sequence number, and the forwarding loop can be identified by the path vector in the device cloud message. The user device D shall choose the optimal link to avoid a forwarding loop.

When Device A executes an application requiring significant computational resources (e.g., high CPU or memory usage), the system is configured to discover nearby devices within communication range. These devices may include other user devices (e.g., smartphones, tablets, or PCs), access points (APs), base stations, or network servers. For example, if a user is seated in proximity to other devices, the system can identify and utilize those devices for resource sharing. These devices in a device cluster, which collaboratively execute the distributed application, may form an application cluster, such as Devices A-B and D-F, as shown in FIG. 8.

The system further integrates with network infrastructure components, such as base stations, customer premises equipment (CPE), access points (APs), edge cloud servers, and core cloud servers. These components may be operated by network service providers (e.g., AT&T, Verizon) and can be utilized as part of the resource-sharing ecosystem. For instance, if a network operator provides computational resources (e.g., CPU, memory) on their network servers, Device A can offload part of its application workload to these resources.

The system dynamically selects resources based on application requirements, such as latency or proximity. For low-latency applications, the system may prioritize nearby access points or base stations. If higher computational power is required, the system may use nearby user devices or network-side machines with stronger computational capabilities.

The system is configured to form clusters or groups of available devices, including user devices, access points, and network servers. Based on the application requirements, the system distributes portions of the application running on Device A across multiple devices within the cluster, enabling efficient resource utilization and improved performance.

In the system depicted in FIG. 8, each circle represents a function or process of the application. To execute the application, six microservices (μs1 through μs6) are required, and all six microservices should operate concurrently. If Device A possesses sufficient computational resources, all six microservices (represented by the six circles) may be executed locally on Device A, as centralized execution is generally more efficient.

However, if Device A has limited resources, the system is configured to distribute portions of the application to other devices. For example, some microservices may be offloaded to nearby devices with greater computational capacity. The arrows between the circles indicate communication paths between microservices (e.g., communication between μs1 and μs2, denoted as ε1), where messages are exchanged to facilitate coordinated execution.

The system operates based on application requirements and resource availability. It dynamically forms clusters or groups of devices and distributes parts of the application to remote devices for execution.

In scenarios involving user mobility, the system accounts for the potential departure of devices from the cluster. For instance, if the owner of Device D moves out of communication range, Microservice 3 (μs3), which was previously executed on Device D, needs to be relocated to another device within the cluster (e.g., Device C or Device G) to maintain application continuity.

The DCO is configured to manage the allocation and execution of microservices across a plurality of devices, including smartphones, servers, and other computational resources. The DCO determines which device handles each microservice, the number of microservices allocated to each device, and when to migrate a microservice to a different device. These decisions are based on the specific requirements of the application.

The application requirements dictate the resource needs of each microservice. For example, Microservice 2 (μs2) may require high CPU utilization, while Microservice 3 (μs3) may be memory-intensive, and another microservice may be visualization-oriented. Each microservice performs distinct functions and has unique resource demands.

The DCO also considers communication constraints between microservices. For instance, communication between Microservice 1 (μs1) and Microservice 2 (μs2) may require low latency or short-distance communication, whereas communication between Microservice 1 (μs1) and Microservice 3 (μs3) may tolerate longer distances or higher latency. If μs1 and μs3 require low-latency communication, then μs3 is placed in proximity to μs1.

The DCO utilizes the application requirements, including resource needs and communication constraints, to determine the optimal placement of microservices across devices. The DCO continuously monitors the system and dynamically adjusts microservice placement as needed.

The service profile parameters, by default, may be classified into three types: Service, Microservice and Communication. However, more types can be extended. The “Service” type contains parameters for the overall application or service, rather than for a specific microservice or a specific communication connectivity.

The “Microservice” type includes computation-related parameters that are necessary for running a specific microservice on a device. Example parameters include the amount of CPU, CPU clock rate, microservice image repository location, image size, required memory and local storage size, scalability, monitoring and feedback capability, service availability, and so on.

The “Communication” type encompasses communication and connectivity-related parameters between specific microservices. Example parameters include source microservice, destination microservice, maximum tolerable packet or message delay, maximum tolerable delay jitter, latency and jitter sensitivity, bandwidth requirement, expected message rate, need for bandwidth reservation, maximum tolerable message/packet error rate, and so on.

A service profile may contain multi-tier sub-service profiles (i.e., a hierarchical service profile) if adaptive QoS is feasible for an application.

The “Service” type in a service profile may include parameters such as Adaptive QOS, which refers to a hierarchical service profile with multi-tier QoS requirements. If the network environment is not adjustable, a lower-tier QoS requirement could be used. An example of a two-tier service profile is the “desired” service profile for optimal performance and the “minimum” service profile for the application to run with bare minimum performance.

The “Service” type may also include a “Cluster Identifier (ID)” parameter, where multiple cluster IDs represent different or parallel clusters. These may be used for deploying a service with multiple application clusters. Alternatively, each cluster may operate independently.

The “Service” type may further include a “QoE Type” parameter. There are at least two types of QoE: objective and subjective. The “objective QoE” indicates that the application's performance can be evaluated based on quantifiable measurements, such as observed data rate, packet delay, delay variation, and packet loss rate (implicit feedback). The QoE estimation for this type of application can be achieved with application QOS measurements without requiring explicit feedback from humans/users. Some real-time applications may belong to this category. The “subjective QoE” category requires explicit human feedback because the level of QoE is determined by how users perceive the usability of a service while in use.

The “Microservice” type in a service profile may include parameters such as CPU, which specifies the minimum compute processing power (e.g., Million Instructions Per Second (MIPS)), and CPU Clock Rate, which defines the required processing speed. The “Microservice” type may also include the URL for the image repository location, where the microservice image is stored. Additionally, parameters such as minimum, average, and maximum memory utilization, as well as minimum, average, and maximum local storage utilization, are defined to provide adequate resource allocation. The scalability parameter determines whether the microservice can be independently scaled.

Every microservice should have monitoring and feedback capability, enabling it to be monitored for resource utilization and performance either through self-monitoring and reporting or by the host device. This capability provides feedback for dynamic orchestration. Service availability, expressed on a scale of 0-100%, defines the required uptime for the microservice. The priority level among the microservices of a distributed application determines the relative importance of each microservice.

The “Communication” type in a service profile may include parameters such as the communication source microservice and communication destination microservice, which define the endpoints of the communication pathway. The maximum tolerable message delay between distributed modules specifies the allowable latency, while the maximum tolerable delay jitter (including packet retransmission, if applicable) defines the acceptable variability in delay. Latency and Jitter Sensitivity, often rated on a scale of 0-10, indicates the severity of the impact if latency requirements are violated.

Furthermore, the bandwidth requirement (in bits per second (bps)) and/or the expected message rate (in messages per second) between distributed modules provide sufficient network capacity. The need for bandwidth reservation provides communication pathways with dedicated resources. The maximum tolerable message/packet error rate defines the acceptable level of data corruption or loss. The priority level among the communication connectivity in the distributed application determines the relative importance of each communication pathway.

A service profile contains the computing and communication performance requirements for an application. These requirements are recorded as key-value pairs in a structured data file format, which is a lightweight data-interchange format that is easy for humans to read and write, as well as for machines to parse and generate. Some of the common standard text-based formats for representing structured data include, but are not limited to, JSON (JavaScript Object Notation), XML (extensible Markup Language), YAML (YAML Ain′t Markup Language), TOML (Tom's Obvious, Minimal Language), INI (Initialization File Format), and Protocol Buffers (Protobuf).

Table 1 shows an exemplary JSON-based text file for a service profile that includes two microservices (ms1 and ms2) and two communications (ms1 to ms2 and ms2 to ms1).

```
{
“service”: {
    “qoe”: “desired”,
    “microservice”: {
        “ms1”: {
                “CPU”: “10MIPS”,
                “CPU_clock”: “3.0GHz”,
                “URL”: “http://localhost/ms1_name.img”,
                “MEM”: “100MB”,
                “Storage”: “100MB”,
                “Service_availability”: “100%”
                },
        “ms2”: {
              “CPU”: “60MIPS”,
              “CPU_clock”: “3.0GHz”,
              “URL”:
              “http://remote_repository.com/ms2_name.img”,
              “MEM”: “100MB”,
              “Storage”: “10MB”,
              “Service_availability”: “95%“
              }
          },
  “communication”: {
      “cm1”: {
            “from”: “ms1”,
            “to”: “ms2”,
            “msg_rate”: “100mps”,
            “avg_msg_size”: “500Byte”,
            “link_util”: “400kbps”,
            “max_delay”: “100msec”,
            “max_jitter”: “200msec”,
            “max_msg_loss_rate”: “1%”
            },
      “cm2”: {
            “from”: “ms2”,
            “to”: “ms1”,
            “msg_rate”: “50mps”,
            “avg_msg_size”: “500Byte”,
            “link_util”: “200kbps”,
            “max_delay”: “100msec”,
            “max_jitter”: “200msec”,
            “max_msg_loss_rate”: “1%”
            }
      }
  }
}
```

The present disclosure designs a virtualized framework for application developers and organizations to test, evaluate, and profile their distributed applications. This framework, referred to as a service profiling system, enables the identification of resource and communication requirements for each microservice within an application. The resulting profile, termed the “service profile,” provides guidelines for deploying the application in a real-world environment.

The service profiling system allows application developers to deploy their distributed applications into the framework. In a semi-automated manner, the system analyzes and identifies the resource requirements for each microservice, as well as the communication requirements between microservices. Specifically, the system determines parameters such as CPU utilization, memory allocation, latency constraints, and data exchange volumes between microservices.

Once the service profile is generated, it serves as a guideline for the orchestrator in a real-world deployment environment. The orchestrator utilizes the service profile to make informed decisions regarding the distribution of microservices across available computational resources.

The service profile may include various parameters that define the resource requirements and capabilities of each microservice. For example, CPU requirements specify the number of CPU cores and their clock rates, accounting for variations in core performance (e.g., faster or slower cores). Additionally, the system considers other CPU capabilities, such as processing power and architecture, to provide optimal allocation.

A microservice may be implemented as a software package. This software package may be stored locally on a device, remotely on a network server, or at a specific location identified by a URL or IP address.

The service profile may also include parameters related to memory requirements, storage requirements, and scalability. For instance, some microservices may be designed for replication, similar to web servers (e.g., google.com) that replicate across multiple locations to handle high traffic. The system evaluates whether a microservice can be replicated and whether resource reservation is necessary to guarantee performance.

Microservices may have varying priority levels, with some requiring higher priority due to their role in the application. The service profile defines these priorities, along with communication parameters between microservices, such as data transfer rates, latency constraints, and bandwidth requirements.

The service profile may define communication parameters between microservices, including the source (sending microservice) and destination (receiving microservice). Key parameters include message delay requirements, delay jitter tolerance, and sensitivity to violations (e.g., whether a delay or jitter violation is critical or non-critical). Bandwidth requirements, such as data volume and transmission speed, are also specified. Additionally, the system considers the number of messages per second, packet error rate, and tolerance for packet loss. For example, in voice communication, losing a few packets may be acceptable, whereas in data transmission, even a single lost packet may be critical.

The service profile is stored in a text file format, which may include well-known formats such as JSON, XML, YAML, TOML, or INI. The specific format is not limited, as long as the required parameters are included. In one embodiment, JSON is used as an example format.

The service profile includes detailed parameters for each microservice. For instance, Microservice 1 (μs1) may require 10 MIPS (Million Instructions Per Second), a CPU clock speed of 3 gigahertz, and a memory allocation of 100 megabytes. The microservice is stored and can be downloaded at a specified URL, with a filename and image format (e.g., IMG). Storage requirements may be set at 10 megabytes, and service availability may be specified as 100% (i.e., continuous operation). Similarly, Microservice 2 (μs2) includes its own set of parameters, as defined in the service profile.

The service profile also considers QoE requirements to provide optimal performance and user satisfaction. These requirements are integrated into the microservice parameters to guide resource allocation and system behavior.

The service profile may define communication parameters for each communication type between microservices. For example, Communication Type 1 (from Microservice 1 (MS1) to Microservice 2 (MS2)) may specify a data transmission rate of 100 megabits per second, an average message size of 500 bytes, link utilization, delay, jitter, and packet loss rate. In some cases, communication may be unidirectional, depending on the functional requirements of the microservices. Therefore, these communication parameters are unidirectional, and corresponding parameters also need to be defined for the reverse direction (e.g., from MS2 to MS1), if applicable.

In scenarios involving multiple microservices, communication paths may be more complex. For instance, Microservice 1 (MS1) may send messages to Microservice 2 (MS2), MS2 may send messages to Microservice 3 (MS3), and MS3 may respond to MS1. The service profile captures these communication patterns and their associated parameters.

At the conclusion of the profiling process, the system generates a service profile text file. This file contains all the defined parameters, including resource requirements for each microservice and communication parameters between multiple intercommunicating microservices. The service profile serves as a comprehensive guide for deploying and orchestrating the application in a distributed environment.

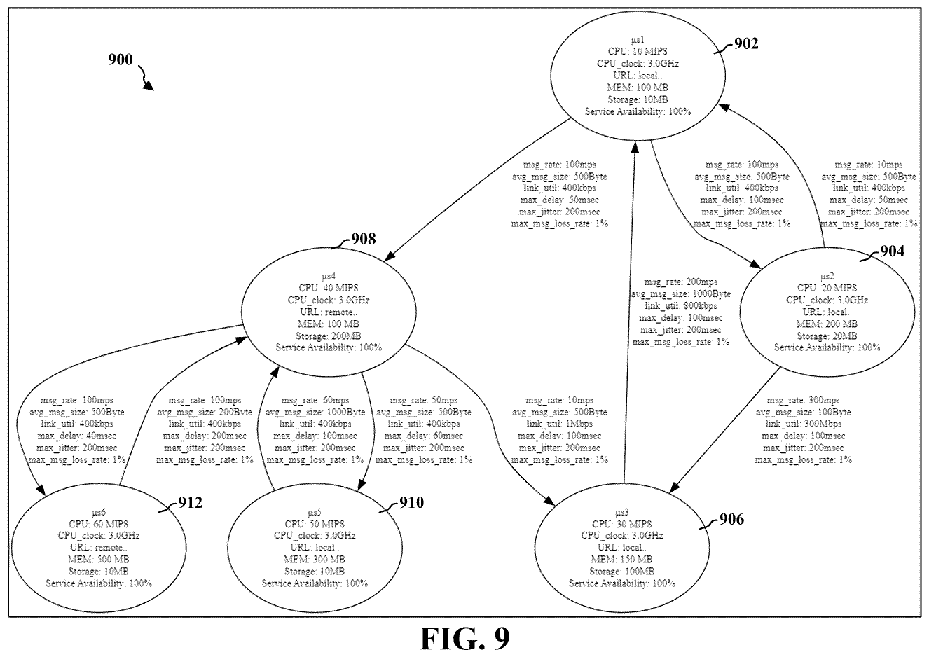

FIG. 9 is a diagram 900 illustrating an exemplary visualization of a service profile, with the compute resource requirements depicted inside six ovals 902-912 representing six microservices (μs1 through μs6), and the communication requirements indicated along the ten arrowed lines connecting the microservices.

FIG. 9 illustrates detailed information about the six microservices and their associated resource requirements, such as CPU utilization, memory allocation, and the URL location of the microservice. The arrowed lines in the visualization represent the communication directions between microservices, along with their corresponding parameters, such as data rate, delay, jitter, and packet loss rate.

The service profile serves as a comprehensive template that outlines the necessary information for deploying and orchestrating a distributed application. It includes resource requirements (e.g., CPU, memory) for each microservice and communication parameters (e.g., latency, bandwidth) between microservices.

The present disclosure focuses on defining the structure and content of the service profile. It proposes the concept of a service profile, which defines the content and structure required for deploying and orchestrating distributed applications. Once the service profile is prepared, it is utilized by the orchestrator to manage the allocation and execution of microservices.

The orchestrator analyzes the service profile to determine the optimal placement of microservices across available devices. It evaluates device capabilities, such as CPU performance, memory availability, and communication metrics (e.g., latency, bandwidth), to decide which microservice should be deployed on which device.

As described supra, FIG. 7 illustrates a user device running a distributed application including six microservices, as an exemplary embodiment. The distributed process communication map 710 depicted in FIG. 7 provides a logical view of the service profile. This map 710 reveals that three microservices (μs1, μs2, μs3) are instantiated individually, while the remaining three (μs4, μs5, μs6) are instantiated as a group. FIG. 7 also shows communication arrows between the microservices, representing the communication pathways (ε1 through ε6) among them. The service profile contains the compute and communication resource requirements for the distributed application. It is not tied to any specific physical topology of user and network devices.

A service profile for each distributed application contains key information in a structured format. This service profile, or its location, may be installed on a device alongside the main application, or it could reside on a network server, particularly in scenarios like internet gaming. In certain implementations, the service profile is pre-prepared and accessible to the system's orchestrator before the distributed application begins execution. This pre-prepared service profile may be deployed in real-time when the application starts.

Each microservice in a service profile is defined with its compute resource requirements. The example parameters include, but are not limited to, CPU (e.g., number of cores, clock rate, MIPS), memory, and storage resource requirements per node or microservice. The service profile also specifies the URL or location of the microservice image, which is the software package to be deployed.

Each communication pathway between the remote processes or microservices in a service profile is defined with specific communication resource requirements or conditions, and perceived link utilization. The example metrics include, but are not limited to, source and destination microservices for the traffic direction, message rate, message size, link delay, link delay variation (jitter), message response time delay, and packet loss rate between the connected nodes or microservices. Also specified are parameters like latency and jitter sensitivity, bandwidth requirements, and whether bandwidth reservation is needed.

A service profile may be prepared in a structured format (e.g., JSON, XML, YAML, TOML, INI, Protocol Buffers) for an orchestrator to use as input. Subsequently, the service profile may be transformed into another format tailored for the specific orchestrator to be used for application deployment. This enables the orchestrator to optimally distribute microservices across worker nodes and configure the communication channels to satisfy the requirements for application QoS and/or Quality of Experience (QoE), performance, and reliability throughout the real-time lifecycle of the distributed application. The service profile acts as a blueprint, guiding the orchestrator's decisions on microservice placement and resource allocation. It allows the orchestrator to meet the performance and resource requirements effectively.

When a distributed application is initiated, a device cluster that may include user devices and network devices is formed, and a main orchestrator (Device Compute Orchestrator, DCO) is elected among the devices in the device cluster. The service profile is sent to the orchestrator, which uses it as a primary source for decision-making during application cluster creation.

When the orchestrator forms an application cluster with remote devices, which may include user devices and network devices, only the applicable parts of the service profile corresponding to a worker node may be delivered to the target worker node, depending on the role of that node. This approach allows each worker node to receive only the relevant configuration information.

While the distributed application is in operation, each microservice, or the underlying worker node (the compute node supporting the microservice), constantly monitors the application's behavior or performance. This includes monitoring CPU, memory, and storage utilization per node; network link utilization, such as packet rate, bandwidth, message rate, and traffic pattern; and network performance metrics, such as packet delay, delay variation (jitter), packet error rate, and message error rate between the connected nodes. The performance monitoring results are fed back to the orchestrator to maintain or to make updates for optimal application cluster performance, enabling dynamic adjustments.

The orchestrator constantly evaluates the application QOS if the application performance is objectively measurable, which includes performance measurement of each microservice and the connectivity performance measurement between microservices. The orchestrator may also, or alternatively, predict the perceived user perspective of application QoE based on algorithms or methods, including Machine Learning (ML) models, using the continuous performance measurements of each microservice and the communication measurements between microservices.

If the observed application performance (QOS and/or QoE) does not meet the desired performance as defined in the service profile, the orchestrator may actively adjust the application cluster. This can involve excluding some low-performing devices, adding new devices, altering network connectivity, or interacting with the systems on the devices in the cluster to reserve needed resources or configure network schedulers and protocols to enhance application performance. The orchestrator's actions are driven by the goal of meeting the service profile's requirements.

In certain implementations, service profile parameters may be classified into three types: Service, Microservice, and Communication types, by default. However, more types can be extended. The “Service” type contains parameters for the overall application or service, rather than for a specific microservice or a specific communication connectivity. The “Microservice” type includes computation-related parameters that are necessary for running a specific microservice on a device. The “Communication” type encompasses communication- and connectivity-related parameters between specific microservices.

The “Service” type parameters within a service profile can define overall application-level characteristics. This may include an “Adaptive QoS” parameter, indicating a hierarchical structure with multiple tiers of QoS requirements (e.g., “desired” and “minimum” performance levels). A “Cluster ID” parameter can distinguish different or parallel clusters, and a “QoE Type” parameter specifies whether QoE is objective (measurable) or subjective (requiring human feedback).

The “Microservice” type parameters within a service profile specify the resource needs of individual microservices. These parameters can include CPU requirements (e.g., MIPS, clock rate), memory utilization (min/avg/max), local storage utilization (min/avg/max), scalability (whether the microservice can be independently scaled), monitoring and feedback capabilities, the need for compute resource reservation, service availability (0-100%), and priority level among the microservices of a distributed application. It also includes the URL or image repository location of the software package of said microservice.

The “Communication” type parameters within a service profile define the communication requirements between microservices. These can include the source and destination microservices, maximum tolerable message delay, maximum tolerable delay jitter, latency and jitter sensitivity, bandwidth requirements, expected message rate, the need for bandwidth reservation, maximum tolerable message/packet error rate, and the priority level among the communication connectivities of the distributed application.

As described, a service profile contains the computing and communication performance requirements for an application. The requirements are recorded as key-value pairs in a structured data file format, which is a lightweight data-interchange format. Common standard text-based formats may include, but are not limited to, JSON, XML, YAML, TOML, INI, and Protocol Buffers. Table 1 presents an example of a JSON-based service profile.

Further, the present disclosure presents a virtualized framework, or system, for application developers and organizations to test, evaluate, and generate profiles of their distributed applications. This framework, referred to as a service profiling system, enables the identification of resource and communication requirements for each microservice within an application. The resulting profile, termed the “service profile,” provides guidelines for deploying the application in a real-world environment using an orchestrator.

The orchestrator utilizes the service profile information, for example as depicted visually in FIG. 9, to inform decisions regarding microservice placement and resource usage across the available devices in a cluster. This approach supports efficient resource utilization and optimal application performance in real-time, during the application's runtime.

This disclosure introduces a service profiling system that enables application developers to test and evaluate their distributed applications. The system analyzes the application's behavior in a controlled environment to identify the resource requirements for each microservice and the communication requirements between microservices. The resulting profile serves as a guideline for the orchestrator when deploying the application in a real-world environment.

In one example, when a distributed application is installed on a device, the service profile or information about its location is also installed. When the application is initiated, the device forms a cluster with other devices, and a main orchestrator is elected among the devices in the cluster. The service profile is then sent to this orchestrator, which uses it to make decisions about application cluster creation.

The orchestrator analyzes the service profile to determine the optimal distribution of microservices across available devices. It evaluates device capabilities, such as CPU performance, memory availability, and communication metrics (e.g., latency, bandwidth), to decide which microservice should be deployed on which device. This approach supports efficient resource utilization and optimal application performance.

The service profile enables the orchestrator to continuously monitor and adapt the application's performance. Each microservice or its underlying worker node constantly monitors the application's behavior and performance, including resource utilization and network metrics. This monitoring data is fed back to the orchestrator, which compares it against the requirements specified in the service profile.

If the observed application performance does not meet the desired levels specified in the service profile, the orchestrator can take corrective actions. These may include excluding underperforming devices, adding new devices to the cluster, altering network connectivity, or configuring network schedulers and protocols to enhance application performance. This dynamic adaptation helps the application maintain optimal performance throughout its lifecycle, even as network conditions and device availability change.

The system supports adaptive Quality of Service (QOS) through multi-tier service profiles. This hierarchical approach allows the application to operate at different performance levels depending on the available resources and network conditions. For example, a two-tier service profile might include a “desired” profile for optimal performance and a “minimum” profile for bare minimum performance.

If the network environment cannot support the requirements specified in the higher-tier profile, the orchestrator can fall back to a lower-tier profile. This approach helps the application continue to function, albeit with reduced performance, rather than failing completely.

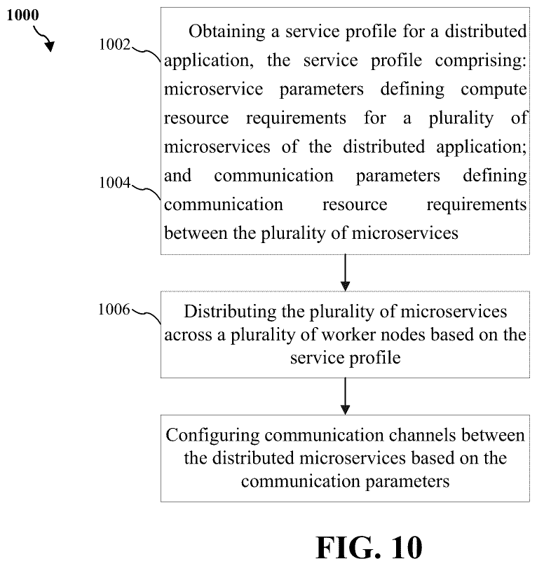

FIG. 10 illustrates a flow chart 1000 of a process for providing distributed application performance through service quality aware device cloud orchestration. The process may be implemented by one or more computing devices.

At block 1002, the one or more computing devices obtain a service profile for a distributed application. The service profile may include: microservice parameters defining compute resource requirements for a plurality of microservices of the distributed application; and communication parameters defining communication resource requirements between the plurality of microservices.

Subsequently, at block 1004, the one or more computing devices distribute the plurality of microservices across a plurality of worker nodes based on the service profile.

At block 1006, the one or more computing devices configure communication channels between the distributed microservices based on the communication parameters.

In certain configurations, the microservice parameters may include at least one of: CPU requirements, CPU clock rate, memory requirements, storage requirements, a microservice image repository location, scalability information, monitoring capability, resource reservation requirements, service availability requirements, or priority level.

In certain configurations, the communication parameters may include at least one of: source microservice identifier, destination microservice identifier, maximum tolerable message delay, maximum tolerable delay jitter, latency sensitivity, jitter sensitivity, bandwidth requirements, expected message rate, bandwidth reservation requirements, or maximum tolerable message error rate.

In certain configurations, the process may further include: forming a device cluster including user devices and network devices; electing a main orchestrator from devices in the device cluster; and sending the service profile to the main orchestrator for decision-making related to application cluster creation.

In certain configurations, the process may further include: delivering, by the main orchestrator, applicable parts of the service profile to target worker nodes based on roles of the target worker nodes in the application cluster.

In certain configurations, the process may further include: monitoring, by each of the plurality of worker nodes, performance metrics of microservices executing on the respective worker nodes; monitoring communication performance metrics between the distributed microservices; and providing the performance metrics to an orchestrator.

In certain configurations, the process may further include: evaluating, by the orchestrator, application Quality of Service (QOS) based on the performance metrics; and adjusting the distribution of the plurality of microservices across the plurality of worker nodes when the application QoS does not meet desired performance levels specified in the service profile.

In certain configurations, the process may further include: predicting, by the orchestrator, application Quality of Experience (QoE) based on the performance metrics and a machine learning model; and adjusting the distribution of the plurality of microservices across the plurality of worker nodes when the predicted application QoE does not meet desired performance levels specified in the service profile.

In certain configurations, adjusting the distribution may include at least one of: excluding low-performing devices from the plurality of worker nodes; adding new devices to the plurality of worker nodes; altering network connectivity between the plurality of worker nodes; or configuring network schedulers and protocols to enhance application performance.

In certain configurations, the service profile may be structured in a data file format including key-value pairs. The data file format may be one of: JavaScript Object Notation (JSON), extensible Markup Language (XML), YAML Ain′t Markup Language (YAML), Tom's Obvious Minimal Language (TOML), Initialization File Format (INI), or Protocol Buffers (Protobuf).

In certain configurations, the service profile may further include service parameters defining requirements for the overall distributed application. The service parameters may include at least one of: adaptive Quality of Service (QOS) parameters defining multi-tier QoS requirements; cluster identifier parameters defining multiple application clusters; or Quality of Experience (QoE) type parameters indicating whether QoE is objective or subjective.

In certain configurations, the adaptive QoS parameters may include: a desired service profile defining optimal performance requirements; and a minimum service profile defining bare minimum performance requirements for the distributed application.

In certain configurations, distributing the plurality of microservices may include: determining whether a single worker node has sufficient resources to host all of the plurality of microservices; instantiating all of the plurality of microservices on the single worker node when the single worker node has sufficient resources; and distributing the plurality of microservices across multiple worker nodes when no single worker node has sufficient resources to host all of the plurality of microservices.

In certain configurations, the process may further include: dynamically adjusting the distribution of the plurality of microservices in response to changes in network conditions or device availability.

In certain configurations, the service profile may be installed on a device when the distributed application is installed. Alternatively, a location of the service profile may be provided to the device when the distributed application is installed.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method, implemented by one or more computing devices, comprising:
obtaining a service profile for a distributed application, the service profile comprising:
microservice parameters defining compute resource requirements for a plurality of microservices of the distributed application; and
communication parameters defining communication resource requirements between the plurality of microservices;
distributing the plurality of microservices across a plurality of worker nodes based on the service profile; and
configuring communication channels between the distributed microservices based on the communication parameters.

2. The method of claim 1, wherein the microservice parameters comprise at least one of:
CPU requirements, CPU clock rate, memory requirements, storage requirements, a microservice image repository location, scalability information, monitoring capability, resource reservation requirements, service availability requirements, or priority level.

3. The method of claim 1, wherein the communication parameters comprise at least one of:
source microservice identifier, destination microservice identifier, maximum tolerable message delay, maximum tolerable delay jitter, latency sensitivity, jitter sensitivity, bandwidth requirements, expected message rate, bandwidth reservation requirements, or maximum tolerable message error rate.

4. The method of claim 1, further comprising:
forming a device cluster comprising user devices and network devices;
electing a main orchestrator from devices in the device cluster; and
sending the service profile to the main orchestrator for decision-making related to application cluster creation.

5. The method of claim 4, further comprising:
delivering, by the main orchestrator, applicable parts of the service profile to target worker nodes based on roles of the target worker nodes in the application cluster.

6. The method of claim 1, further comprising:
monitoring, by each of the plurality of worker nodes, performance metrics of microservices executing on the respective worker nodes;
monitoring communication performance metrics between the distributed microservices; and
providing the performance metrics to an orchestrator.

7. The method of claim 6, further comprising:
evaluating, by the orchestrator, application Quality of Service (QOS) based on the performance metrics; and
adjusting the distribution of the plurality of microservices across the plurality of worker nodes when the application QoS does not meet desired performance levels specified in the service profile.

8. The method of claim 6, further comprising:
predicting, by the orchestrator, application Quality of Experience (QoE) based on the performance metrics and a machine learning model; and
adjusting the distribution of the plurality of microservices across the plurality of worker nodes when the predicted application QoE does not meet desired performance levels specified in the service profile.

9. The method of claim 7, wherein adjusting the distribution comprises at least one of:
excluding low-performing devices from the plurality of worker nodes;
adding new devices to the plurality of worker nodes;
altering network connectivity between the plurality of worker nodes; or
configuring network schedulers and protocols to enhance application performance.

10. The method of claim 1, wherein the service profile is structured in a data file format comprising key-value pairs, the data file format being one of: JavaScript Object Notation (JSON), extensible Markup Language (XML), YAML Ain't Markup Language (YAML), Tom's Obvious Minimal Language (TOML), Initialization File Format (INI), or Protocol Buffers (Protobuf).

11. The method of claim 1, wherein the service profile further comprises service parameters defining requirements for the overall distributed application, the service parameters including at least one of:
adaptive Quality of Service (QOS) parameters defining multi-tier QoS requirements;
cluster identifier parameters defining multiple application clusters; or
Quality of Experience (QoE) type parameters indicating whether QoE is objective or subjective.

12. The method of claim 11, wherein the adaptive QoS parameters comprise:
a desired service profile defining optimal performance requirements; and
a minimum service profile defining bare minimum performance requirements for the distributed application.

13. The method of claim 1, wherein distributing the plurality of microservices comprises:
determining whether a single worker node has sufficient resources to host all of the plurality of microservices;
instantiating all of the plurality of microservices on the single worker node when the single worker node has sufficient resources; and
distributing the plurality of microservices across multiple worker nodes when no single worker node has sufficient resources to host all of the plurality of microservices.

14. The method of claim 1, further comprising:
dynamically adjusting the distribution of the plurality of microservices in response to changes in network conditions or device availability.

15. The method of claim 1, wherein the service profile is installed on a device when the distributed application is installed, or wherein a location of the service profile is provided to the device when the distributed application is installed.

16. A system, comprising one or more computing devices, wherein the system is configured to:
obtain a service profile for a distributed application, the service profile comprising:
microservice parameters defining compute resource requirements for a plurality of microservices of the distributed application; and
communication parameters defining communication resource requirements between the plurality of microservices;
distribute the plurality of microservices across a plurality of worker nodes based on the service profile; and
configure communication channels between the distributed microservices based on the communication parameters.

17. The system of claim 16, wherein the system is further configured to:
form a device cluster comprising user devices and network devices;
elect a main orchestrator from devices in the device cluster; and
send the service profile to the main orchestrator for decision-making related to application cluster creation.

18. The system of claim 17, wherein the system is further configured to:
deliver, by the main orchestrator, applicable parts of the service profile to target worker nodes based on roles of the target worker nodes in the application cluster.

19. The system of claim 16, wherein the system is further configured to:
monitor, by each of the plurality of worker nodes, performance metrics of microservices executing on the respective worker nodes;
monitor communication performance metrics between the distributed microservices; and
provide the performance metrics to an orchestrator.

20. A computer-readable medium storing computer executable code for a process implemented by one or more computing devices, comprising code to:
obtain a service profile for a distributed application, the service profile comprising:
microservice parameters defining compute resource requirements for a plurality of microservices of the distributed application; and
communication parameters defining communication resource requirements between the plurality of microservices;
distribute the plurality of microservices across a plurality of worker nodes based on the service profile; and
configure communication channels between the distributed microservices based on the communication parameters.
